(19) United States
(12) Patent Application Publication
(10) Pub. No.: US 2026/0124669 A1
(43) Pub. Date: May 7, 2026

(54) TEMPERATURE ADJUSTMENT UNIT AND MANUFACTURING METHOD OF TEMPERATURE ADJUSTMENT UNIT

(71) Applicant: TOYOTA JIDOSHA KABUSHIKI KAISHA, Toyota-shi (JP)

(72) Inventors: Sho KOBAYASHI, Seto-shi (JP); Daichi TAJIMA, Toyota-shi (JP); Kohei TAKAHASHI, Nisshin-shi (JP); Yoshiyuki HAYASHI, Nissin-shi (JP); Yutaroh GOTOH, Toyota-shi (JP)

(73) Assignee: TOYOTA JIDOSHA KABUSHIKI KAISHA, Toyota-shi (JP)

(21) Appl. No.: 19/298,734

(22) Filed: Aug. 13, 2025

(30) Foreign Application Priority Data
Nov. 1, 2024 (JP) 2024-192819

(51) Int. Cl. B21D 53/04; F28F 3/00

(52) U.S. Cl. CPC B21D 53/04; F28F 3/00

(57) ABSTRACT

In a temperature adjustment unit, a first metal plate member and a second metal plate member are provided with a groove portion serving as a flow path of a fluid, the first and the second metal plate members being superposed and joined to each other. The temperature adjustment unit includes: a chemical bonding section in which a planar portion of the first metal plate member and a planar portion of the second metal plate member are bonded by chemical bonding, the planar portions facing each other; a mechanical joint section provided in the chemical bonding section and joined by mechanical joining; and a joint planar section provided around the mechanical joint section. The joint planar section projects with respect to the groove portion in a direction transverse to the flow path and is alternately provided on opposite sides of the flow path along a flow direction of the fluid.

### CROSS-REFERENCE TO RELATED APPLICATION

This application claims priority to Japanese Patent Application No. 2024-192819 filed on Nov. 1, 2024. The disclosure of the above-identified application, including the specification, drawings, and claims, is incorporated by reference herein in its entirety.

### BACKGROUND

### 1. Technical Field

The present disclosure relates to a temperature adjustment unit and a manufacturing method of a temperature adjustment unit.

### 2. Description of Related Art

Japanese Unexamined Patent Application Publication No. 2024-61456 (JP 2024-61456 A) discloses a temperature adjustment unit. In the temperature adjustment unit, an adhesive is applied around a groove serving as a flow path of a fluid, the groove being provided in at least one of a first metal plate member and a second metal plate member, the two metal plate members are superposed, and then a mechanical joint section is provided at a portion to which the adhesive is applied.

### SUMMARY

In JP 2024-61456 A, in order to perform mechanical joining on the two superposed metal plate members, a joint planar section having a circular shape that has a diameter that is predetermined needs to be provided. In a case where a width of the flow path is widened in order to increase heat exchange efficiency of the temperature adjustment unit, the joint planar section may protrude into the flow path. In a case where the joint planar section protrudes into the flow path, a flow of the fluid is hindered, and thus heat exchange efficiency that is needed cannot be achieved.

The present disclosure has been made in order to solve such problems, and an object of the present disclosure is to provide a temperature adjustment unit and a manufacturing method of a temperature adjustment unit, in which even in a case where a joint planar section for performing mechanical joining protrudes into a flow path, heat exchange efficiency that is needed can be obtained without hindering a flow of a fluid.

The present disclosure is a temperature adjustment unit in which at least one of a first metal plate member and a second metal plate member is provided with a groove portion serving as a flow path of a fluid, the first metal plate member and the second metal plate member being superposed and joined to each other, the temperature adjustment unit including:
a chemical bonding section where a planar portion of the first metal plate member and a planar portion of the second metal plate member are bonded by chemical bonding, the planar portions facing each other;
a mechanical joint section provided in the chemical bonding section and joined by mechanical joining; and
a joint planar section provided around the mechanical joint section,
in which the joint planar section projects with respect to the groove portion in a direction transverse to the flow path and is alternately provided on opposite sides of the flow path along a flow direction of the fluid.

With such a configuration, heat exchange efficiency that is needed can be obtained without hindering a flow of a fluid.

The groove portion is provided to meander and the mechanical joint section is provided between the adjacent flow paths. With such a configuration, heat exchange efficiency that is needed can be obtained without hindering a flow of a fluid.

The mechanical joint section is joined by clinching. With such a configuration, heat exchange efficiency that is needed can be obtained without hindering a flow of a fluid.

A manufacturing method of the temperature adjustment unit according to the present disclosure, the manufacturing method includes:
performing surface modification on the planar portion of the first metal plate member and on the planar portion of the second metal plate member, the planar portions facing each other;
applying an adhesive to at least one of the planar portion of the first metal plate member and the planar portion of the second metal plate member, the planar portions facing each other;
superposing the planar portion of the first metal plate member and the planar portion of the second metal plate member, the planar portions facing each other; and
joining the planar portion of the first metal plate member and the planar portion of the second metal plate member that are superposed, by clinching, the planar portions facing each other.

With such a configuration, the adhesive can be retained in the mechanical joint section during mechanical joining, and a bonding strength between the first metal plate member and the second metal plate member is increased.

According to the present disclosure, it is possible to provide a temperature adjustment unit and a manufacturing method of a temperature adjustment unit, in which even in a case where a joint planar section for performing mechanical joining protrudes into a flow path, heat exchange efficiency that is needed can be obtained without hindering a flow of a fluid.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view of a temperature adjustment unit according to Embodiment 1;

FIG. 2 is a cross-sectional view of the temperature adjustment unit taken along a two-dot chain line of FIG. 1 in a II direction;

FIG. 3 is a schematic configuration view for describing clinching; and

FIG. 4 is a cross-sectional view corresponding to FIG. 2, showing the temperature adjustment unit according to Embodiment 2.

### DETAILED DESCRIPTION OF EMBODIMENTS

Hereinafter, embodiments of the present disclosure will be described with reference to the drawings.

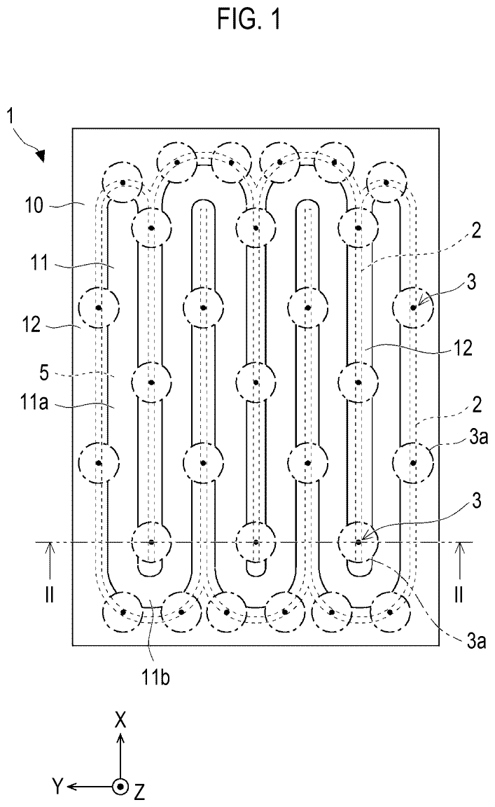

FIG. 1 is a schematic plan view of a temperature adjustment unit according to Embodiment 1.

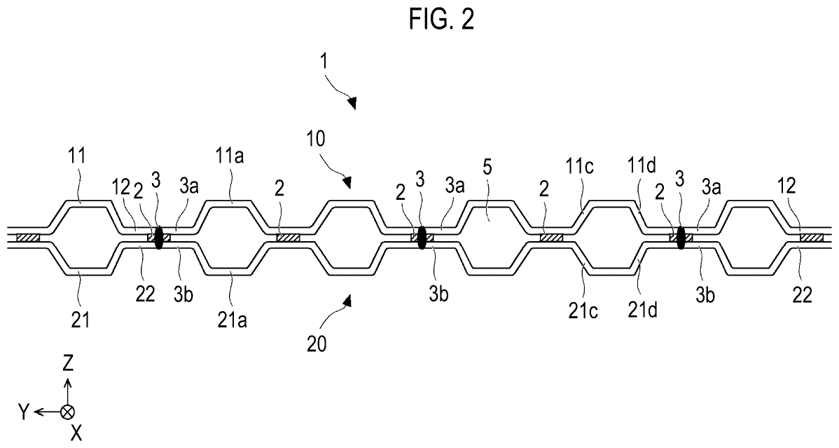

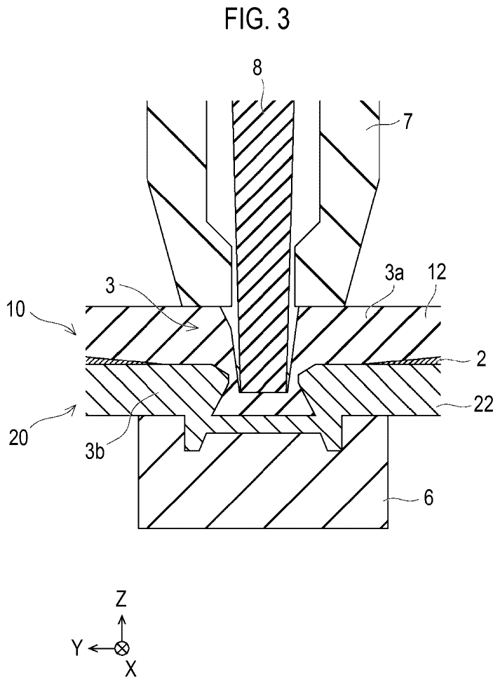

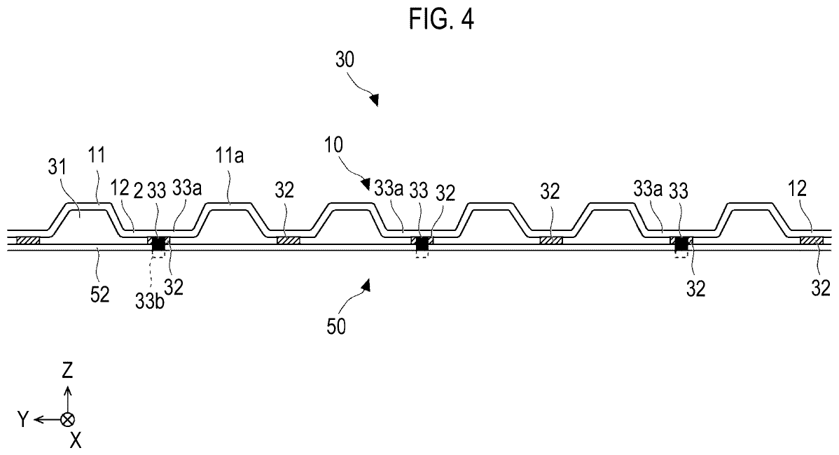

FIG. 2 is a cross-sectional view of the temperature adjustment unit taken along a two-dot chain line in FIG. 1 in a II direction. FIG. 3 is a schematic configuration view for describing clinching. FIG. 4 is a cross-sectional view corresponding to FIG. 2, showing the temperature adjustment unit according to Embodiment 2.

A right-handed XYZ orthogonal coordinate shown in FIGS. 1 to 4 is merely a convenient reference for describing a positional relationship between the components. In FIGS. 1 to 4, a Z-axis positive direction is a vertical upward direction, and an XY plane is a horizontal plane.

### Embodiment 1

A temperature adjustment unit 1 according to Embodiment 1 will be described with reference to FIGS. 1 and 2. The temperature adjustment unit 1 is a temperature adjustment unit 1 that cools a battery mounted on a vehicle.

As shown in FIGS. 1 and 2, the temperature adjustment unit 1 includes a first metal plate member 10 and a second metal plate member 20. Reference numeral in parentheses shown in FIG. 1 is a reference numeral of a component of the second metal plate member 20 located on a back side of the paper surface. The first metal plate member 10 is configured of a rectangular plate member in a plan view and is made of a metal material such as aluminum or iron.

The first metal plate member 10 has a groove portion 11 and a planar portion 12. As shown in FIG. 2, the groove portion 11 is configured of a groove recessed in a thickness direction (Z-axis direction in FIG. 2) of the first metal plate member 10. The groove portion 11 has a substantially U-shaped cross section provided by press working or the like.

As shown in FIG. 1, the groove portion 11 extends while meandering from a first end side to a second end side in a lateral direction (Y-axis direction in FIG. 1) of the first metal plate member 10. The groove portion 11 has a linear portion 11a and a return portion 11b. The linear portion 11a extends in a longitudinal direction (X-axis direction in FIG. 1) of the first metal plate member 10 and is provided to be arranged in plurality in the lateral direction (Y-axis direction in FIG. 1) of the first metal plate member 10. The return portion 11b is provided at both end portions of the first metal plate member 10 in the longitudinal direction (X-axis direction in FIG. 1) to connect end portions of the linear portions 11a that are adjacent.

The groove portion 11 constitutes a part of a flow path 5 for flowing a fluid for cooling the battery. The fluid flows in the recess provided by the groove portion 11. The fluid is coolant, cooling air, or the like. An inlet (not shown) is provided at a first end portion of the groove portion 11 in a length direction, and the fluid is introduced into the flow path 5 from the inlet. An outlet (not shown) is provided at a second end portion of the groove portion 11 in the length direction, and the fluid flowing through the flow path 5 is discharged from the outlet.

The planar portion 12 is provided on the first metal plate member 10. The planar portion 12 is configured of a flat surface extending in the longitudinal direction (X-axis direction in FIG. 1) and the lateral direction (Y-axis direction in FIG. 1) of the first metal plate member 10. The planar portion 12 is provided in an outer peripheral region of the groove portion 11 and between the linear portions 11a that are adjacent.

As shown in FIG. 2, the second metal plate member 20 is provided on one side of the first metal plate member 10 in the thickness direction (Z-axis direction in FIG. 2). As shown in FIGS. 1 and 2, the second metal plate member 20 has a groove portion 21, a linear portion 21a, a return portion 21b, and a planar portion 22, similarly to the first metal plate member 10. Since the shape and the structure of the second metal plate member 20 are the same as those of the first metal plate member 10, detailed description thereof will be omitted.

As shown in FIG. 2, the first metal plate member 10 and the second metal plate member 20 are superposed and joined in a direction in which an opening of the groove portion 11 of the first metal plate member 10 and an opening of the groove portion 21 of the second metal plate member 20 face each other. In a case where the first metal plate member 10 and the second metal plate member 20 are joined, the flow path 5 for flowing the fluid for cooling the battery is provided by the groove portion 11 of the first metal plate member 10 and the groove portion 21 of the second metal plate member 20.

As shown in FIG. 2, the temperature adjustment unit 1 has a chemical bonding section 2 in which the planar portion 12 of the first metal plate member 10 and the planar portion 22 of the second metal plate member 20 facing each other are bonded to each other by chemical bonding. The chemical bonding is bonding using an adhesive.

As shown in FIG. 1, the chemical bonding section 2 is provided in a linear shape continuously around an entirety of an outer periphery of the groove portion 11 of the first metal plate member 10 and the groove portion 21 of the second metal plate member 20. Further, the chemical bonding section 2 is also provided in a linear shape continuously between the linear portions 11a that are adjacent and between the linear portions 21a that are adjacent.

In the temperature adjustment unit 1, surface modification is performed before the adhesive is applied to the chemical bonding section 2 in order to improve wettability. Examples of the surface modification include surface roughening and laser irradiation, dry-ice blasting, and sanding for removing press oil, mold release agents, and foreign substances. The examples of the surface modification further include plasma irradiation for imparting an OH group. The surface modification is performed on an entirety of the surfaces of the planar portion 12 of the first metal plate member 10 and the planar portion 22 of the second metal plate member 20. The surface modification may be performed solely on the chemical bonding section 2 to which the adhesive is applied.

After performing the surface modification, the adhesive is applied to any one of the planar portion 12 of the first metal plate member 10 and the planar portion 22 of the second metal plate member 20 facing each other. The adhesive may be applied to both the planar portion 12 of the first metal plate member 10 and the planar portion 22 of the second metal plate member 20 facing each other. The adhesive includes a liquid adhesive and a solid adhesive such as a double-sided tape. After applying the adhesive, the planar portion 12 of the first metal plate member 10 and the planar portion 22 of the second metal plate member 20 facing each other are superposed and joined to each other.

As shown in FIGS. 1 and 2, the temperature adjustment unit 1 has a mechanical joint section 3 in which the planar portion 12 of the first metal plate member 10 and the planar portion 22 of the second metal plate member 20 facing each other are joined to each other by mechanical joining. The mechanical joining is joining by clinching. The mechanical joining may be performed by a rivet, a bolt, or the like instead of the clinching.

The mechanical joint section 3 is provided in a portion where the chemical bonding section 2 is provided. The mechanical joint section 3 is provided not only on the outer periphery of the groove portion 11 of the first metal plate member 10 and the groove portion 21 of the second metal plate member 20 but also between the linear portions 11a that are adjacent and between the linear portions 21a that are adjacent. The mechanical joining is performed after applying the adhesive to the chemical bonding section 2 and superposing the planar portion 12 of the first metal plate member 10 and the planar portion 22 of the second metal plate member 20 facing each other, and before the adhesive is cured.

As shown in FIGS. 1 and 2, joint planar sections 3a and 3b are provided around the mechanical joint section 3. As shown in FIG. 2, the joint planar section 3a is provided on the planar portion 12 of the first metal plate member 10, and the joint planar section 3b is provided on the planar portion 22 of the second metal plate member 20. As shown in FIGS. 1 and 2, the joint planar sections 3a and 3b are configured of planes having a circular shape in a plan view.

The joint planar sections 3a and 3b are needed for the clinching. FIG. 3 is a schematic configuration view for describing clinching. As shown in FIG. 3, when the clinching is performed, a stripper 7 into which a punch 8 is inserted is placed on the joint planar section 3a. In addition, when the clinching is performed, a die 6 is placed on the joint planar section 3b. The clinching is performed by pushing the punch 8 toward the die 6. As shown in FIG. 1, the mechanical joint section 3 that is subjected to the clinching is provided at the center of the joint planar sections 3a and 3b.

As shown in FIG. 1, the joint planar section 3a is provided with a diameter larger than a width of the planar portion 12 between the linear portions 11a that are adjacent. In addition, the joint planar section 3b is provided with a diameter larger than a width of the planar portion 22 between the linear portions 21a that are adjacent.

As shown in FIG. 1, the joint planar section 3a is provided to project in a direction transverse to the flow path 5 with respect to the groove portion 11. In addition, the joint planar section 3b is provided to project in a direction transverse to the flow path 5 with respect to the groove portion 21.

As shown in FIG. 1, the joint planar section 3a is alternately provided on opposite sides of the flow path 5 along the flow direction of the fluid in the linear portion 11a. In addition, the joint planar section 3b is alternately provided on opposite sides of the flow path 5 along the flow direction of the fluid in the linear portion 21a.

Since the joint planar section 3a is alternately provided on opposite sides of the flow path 5 along the flow direction of the fluid in the linear portion 11a, as shown in FIG. 2, the cross-sectional shape of the groove portion 11 in which the joint planar section 3a is provided on the side surface of the flow path 5 is asymmetrical in a width direction. Specifically, a side surface portion 11d on a side on which the joint planar section 3a is provided is provided at an angle close to perpendicular to a side surface portion 11c of the groove portion 11 on a side on which the joint planar section 3a is not provided.

Similarly, since the joint planar section 3b is alternately provided on opposite sides of the flow path 5 along the flow direction of the fluid in the linear portion 21a, as shown in FIG. 2, the cross-sectional shape of the groove portion 21 in which the joint planar section 3b is provided on the side surface of the flow path 5 is asymmetrical in the width direction. Specifically, a side surface portion 21d on a side on which the joint planar section 3b is provided is provided at an angle close to perpendicular to a side surface portion 21c of the groove portion 21 on a side on which the joint planar section 3b is not provided.

In the temperature adjustment unit 1, the mechanical joint section 3 is provided in a portion where the chemical bonding section 2 is provided. Therefore, a bonding strength between the first metal plate member 10 and the second metal plate member 20 is increased while the size of the temperature adjustment unit 1 is compact, and sealability is improved.

The joint planar section 3a is alternately provided on opposite sides of the flow path 5 along the flow direction of the fluid in the linear portion 11a. In addition, the joint planar section 3b is alternately provided on opposite sides of the flow path 5 along the flow direction of the fluid in the linear portion 21a of the groove portion 21. Therefore, even in a case where the joint planar sections 3a and 3b protrude into the flow path 5, heat exchange efficiency that is needed can be obtained without hindering a flow of a fluid.

In the temperature adjustment unit 1, surface modification is performed before the adhesive is applied to the chemical bonding section 2 in order to improve wettability. Therefore, the adhesive can be retained in the mechanical joint section 3 during mechanical joining, and a bonding strength between the first metal plate member 10 and the second metal plate member 20 is increased.

### Embodiment 2

A temperature adjustment unit 30 according to Embodiment 2 will be described with reference to FIG. 4. FIG. 4 is a cross-sectional view corresponding to FIG. 2, showing the temperature adjustment unit 30 according to Embodiment 2. In Embodiment 2, the second metal plate member and the mechanical joint section are different from those of Embodiment 1.

As shown in FIG. 4, the temperature adjustment unit 30 includes the first metal plate member 10 and a second metal plate member 50. Since the shape and the structure of the first metal plate member 10 are the same as those of the first metal plate member 10 of Embodiment 1, detailed description thereof will be omitted.

The second metal plate member 50 is configured of a rectangular plate member in a plan view and is made of a metal material such as aluminum or iron. A groove portion is not provided in the second metal plate member 50, and solely a planar portion 52 is provided.

As shown in FIG. 4, the first metal plate member 10 and the second metal plate member 50 are superposed and joined to each other with a side of the first metal plate member 10 on which the groove portion 11 opens facing the second metal plate member 50. In a case where the first metal plate member 10 and the second metal plate member 50 are joined, a flow path 31 for flowing a fluid for cooling the battery is provided by the groove portion 11 of the first metal plate member 10 and the planar portion 52 of the second metal plate member.

As shown in FIG. 4, the temperature adjustment unit 30 has a chemical bonding section 32 in which the planar portion 12 of the first metal plate member 10 and the planar portion 52 of the second metal plate member 50 facing each other are bonded to each other by chemical bonding. Since the configuration of the chemical bonding section 32 is the same as that of the chemical bonding section 2 of Embodiment 1, detailed description thereof will be omitted.

As shown in FIG. 4, the temperature adjustment unit 30 has a mechanical joint section 33 in which the planar portion 12 of the first metal plate member 10 and the planar portion 52 of the second metal plate member 50 facing each other are joined to each other by mechanical joining. The mechanical joining is joining by clinching. The mechanical joint section 33 is provided in a portion where the chemical bonding section 32 is provided. The mechanical joining is performed after applying the adhesive to the chemical bonding section 32 and superposing the planar portion 12 of the first metal plate member 10 and the planar portion 22 of the second metal plate member 20 facing each other, and before the adhesive is cured.

As shown in FIG. 4, a joint planar section 33a is provided around the mechanical joint section 33. The joint planar section 33a is provided on the planar portion 12 of the first metal plate member 10. The joint planar section 33a is configured of a plane having a circular shape in a plan view.

During clinching, a stripper into which a punch is inserted is placed on the joint planar section 33a. A die is placed on the planar portion 52 of the second metal plate member 50 facing the joint planar section 33a when the clinching is performed. When the clinching is performed, a protruding portion 33b (shown by a broken line in FIG. 4) that protrudes outward in the thickness direction from the planar portion 52 of the second metal plate member 50 is provided in the mechanical joint section 33. The protruding portion 33b is crushed by being sandwiched between two tools from the thickness direction (Z-axis direction in FIG. 4) of the temperature adjustment unit 30. As a result, the planar portion 52 of the second metal plate member 50 is configured of a plane.

Since the configurations of the other mechanical joint section 33 and the other joint planar section 33a are the same as those of the mechanical joint section 3 and the joint planar section 3a of Embodiment 1, detailed description thereof will be omitted.

In the temperature adjustment unit 30, since the second metal plate member 50 is configured of solely the planar portion 52, the battery can be brought into contact with the surface of the planar portion 52. Therefore, it is possible to improve cooling performance of the battery.

In the embodiment, the temperature adjustment unit cools the battery mounted on the vehicle, but can also be applied to any component such as a motor that requires cooling or heating.

In the clinching of Embodiment 2, the stripper into which the punch is inserted is disposed on the first metal plate member side, and the die is disposed on the second metal plate member side, but the die may be disposed on the first metal plate member side, and the stripper may be disposed on the second metal plate member side. In this case, since a protruding portion is not provided on the surface of the second metal plate member, a step of crushing the protruding portion with a tool can be omitted.

The present disclosure is not limited to the embodiment, and can be appropriately modified without departing from the spirit.

What is claimed is:

1. A temperature adjustment unit in which at least one of a first metal plate member and a second metal plate member is provided with a groove portion serving as a flow path of a fluid, the first metal plate member and the second metal plate member being superposed and joined to each other, the temperature adjustment unit comprising:
a chemical bonding section where a planar portion of the first metal plate member and a planar portion of the second metal plate member are bonded by chemical bonding, the planar portions facing each other;
a mechanical joint section provided in the chemical bonding section and joined by mechanical joining; and
a joint planar section provided around the mechanical joint section,
wherein the joint planar section projects with respect to the groove portion in a direction transverse to the flow path and is alternately provided on opposite sides of the flow path along a flow direction of the fluid.

2. The temperature adjustment unit according to claim 1, wherein:
the groove portion is provided to meander; and
the mechanical joint section is provided between the flow paths adjacent each other.

3. The temperature adjustment unit according to claim 1, wherein the mechanical joint section is joined by clinching.

4. A manufacturing method of the temperature adjustment unit according to claim 1, the manufacturing method comprising:
performing surface modification on the planar portion of the first metal plate member and on the planar portion of the second metal plate member, the planar portions facing each other;
applying an adhesive to at least one of the planar portion of the first metal plate member and the planar portion of the second metal plate member, the planar portions facing each other;
superposing the planar portion of the first metal plate member and the planar portion of the second metal plate member, the planar portions facing each other; and
joining the planar portion of the first metal plate member and the planar portion of the second metal plate member that are superposed, by clinching, the planar portions facing each other.
